(19) United States
(12) Patent Application Publication
(10) Pub. No.: US 2005/0270774 A1
(43) Pub. Date: Dec. 8, 2005

(54) LED illuminating strip unit

(76) Inventor: Frank Pan, Rosemead, CA (US)

Correspondence Address: RAYMOND Y. CHAN, 108 N. YNEZ AVE., SUITE 128, MONTEREY PARK, CA, 91754, US

(21) Appl. No.: 10/861,647

(22) Filed: Jun. 3, 2004

(51) Int. Cl. F21S 4/00

(52) U.S. Cl. 362/217

(57) ABSTRACT

A LED illuminating strip includes an elongated support housing having a light accumulating channel, a plurality of illuminators spacedly aligned along the light accumulating channel, and a light merging arrangement. Each of the illuminators forms as a point of light source for radially emitting light within the light accumulating channel. The light merging arrangement is provided at the support housing to reflectively accumulate the lights from the illuminators within the light accumulating channel, so as to merge the points of light source to form a line of consistent light source along the light accumulating channel.

### BACKGROUND OF THE PRESENT INVENTION

1. Field of Invention

The present invention relates to a lighting device, and more particularly to a Light Emitting Diode (LED) illuminating strip unit which is capable of generating a line of light source from a plurality of discrete points of light sources.

2. Description of Related Arts

Fluorescent lamps have long been utilized for a wide variety of lighting purposes, notably for advertisements and domestic use. People prefer fluorescent lamps to traditional light bulbs because they are generally more long-lasting and brighter when compared with traditional light bulbs. Moreover, each of such fluorescent lamps is capable of producing a line light source which is more preferable for practical use. For example, when a particular trademark has to be lightened, fluorescent lamps are suitable for generating consistent line of light of different shapes.

Yet in order to further enhance the lighting performance of the conventional fluorescent lamps, there exist some kinds of neon lights which are capable of producing high intensity of light from a line source. Such kinds of neon lights have successfully accomplished the task of producing high quality of light from consistent line sources. For example, a prominent US city where a substantial amount of neon lights have been utilized for advertisements is Las Vegas in the state of Nevada.

Despite the advantages and popularity of the conventional fluorescent lamps and neon lights, they definitely have discrepancies. First of all, a practical disadvantage of them is that they are generally fragile. As a matter of fact, almost all of the fluorescent lamps have an outer light tube which is generally made of transparent materials, such as glass. As a result, although the outer light tube is good for light transmission, it is fragile and vulnerable to external forces.

Second, conventional neon lights and fluorescent lamps will generate a substantial amount of heat when operating and therefore inevitably produce a substantial amount of energy waste. Although one might argue that the fluorescent lamps, when compared with conventional light bulbs, have already saved a lot of energy and produced a reduced amount of heat when operating. Nonetheless, the fact that the fluorescent lamps produce less amount of heat as compared with conventional light bulbs does not mean that the relevant problem is effectively remedied.

In addition, conventional fluorescent lamps will develop a substantial potential difference between their respective terminals so as to create a great risk to their user. When electricity leak occurred, the consequence would be catastrophic.

Moreover, the substantial potential difference, from engineering point of view, is created by electrons movement between the two terminals. As a result, when the fluorescent lamps are operating, they tend to be unstable in that a light pattern generated by the fluorescent lamp may follow the path of the electrons movement, thus creating a changing light pattern. This is especially true when the fluorescent lamp is nearly put of its product life-time.

Due to the above discrepancies, there exists another type of illuminating device which is generally called the Light Emitting Diode (LED). Conventionally, each LED is capable of generating light in a very efficient manner. It consumes less energy than conventional neon lights and fluorescent lamps, usually non-fragile, and generates only very little amount of heat when operating. One reason for this is that for LED, most energy inputted will be converted into light (i.e. electromagnetic wave with visual wavelength). Thus, as most energy inputted is converted into light, less heat is generated. Thus, LED seems to be a perfect substitute for the conventional neon lights and fluorescent lamps.

Nothing is perfect, however. A fatal disadvantage of LED is a by-product of the above-mentioned advantages. If one is trying to ask why LED consumes less energy, a probable answer might be that because LED produces lower light intensity. As a result, it is a usual practice that a plurality of LEDs is chained together to form a rope light or some other forms of illuminating devices for producing a desirable light effect. However, since each LED can only produce light from essentially a point source, when a plurality of LEDs is chained together, illumination of unsatisfactory pattern may be produced. Generally speaking, light of irregular pattern, meaning that it is not the kind of light coming from a point source nor a line source, ultimately results.

Technically, a point source of light would produce light which is radially extended therefrom to form a spherical pattern. On the other hand, a line source of light would produce light which is extended to form a cylindrical pattern. Thus, where a plurality of LEDs is chained together, the resulting light produced is not wholly spherical nor cylindrical. This produces unsatisfactory illumination effect for such conventional illuminating devices as rope light or light strip.

### SUMMARY OF THE PRESENT INVENTION

A main object of the present invention is to provide a LED illuminating strip unit which is capable of generating a line of light source from a plurality of discrete points of light sources, such as those from a plurality of Light Emitting Diodes (LEDs).

Another object of the present invention is to provide a LED illuminating strip unit comprising a support housing having an elongated light accumulating channel which is adapted to optically accumulate light from a plurality of discrete point sources, such as those from a plurality of LEDs, to form a single line source.

Another object of the present invention is to provide a LED illuminating strip unit in which the support housing is adapted to embody as a light source of elongated shape, such as an illuminating handrails, so as to provide an economical, safe, and reliable line source of light in a wide variety of circumstances.

Another object of the present invention is to provide a LED illuminating strip unit which does not involve any expensive or complicated electrical or mechanical components so as to minimize the manufacturing cost and the ultimate selling price of the present invention.

Another object of the present invention is to provide a LED illuminating strip unit wherein the support housing is adapted to alter a lighting effect of the single line of light source generated therefrom for widening and optimizing an application of the present invention.

Accordingly, in order to accomplish the above objects, the present invention provides a LED illuminating strip unit, comprising:
an elongated support housing having two opposed sidewalls upwardly extended from a bottom wall of the elongated support housing to form a light accumulating channel within the sidewalls and the bottom wall;
an illumination unit comprising a light circuit supported by the support housing for electrically connecting to a power source and a plurality of illuminators which are electrically mounted to the light circuit and spacedly aligned along the light accumulating channel, wherein each of the illuminators forms as a point of light source for radially emitting light within the light accumulating channel; and
a light merging arrangement provided at the support housing to reflectively accumulate the lights from the illuminators within the light accumulating channel, so as to merge the points of light source to form a line of consistent light source along the light accumulating channel.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED illuminating strip unit according to a first preferred embodiment of the present invention.

FIG. 2A is a side sectional view of the LED illuminating strip unit according to the above first preferred embodiment of the present invention.

FIG. 2B is a front sectional view of the LED illuminating strip unit according to the above first preferred embodiment of the present invention.

FIG. 3 is a perspective view of the LED illuminating strip unit according to a second preferred embodiment of the present invention.

FIG. 4A is a side sectional view of the LED illuminating strip unit according to the above second preferred embodiment of the present invention.

FIG. 4B is a front sectional view of the LED illuminating strip unit according to the above second preferred embodiment of the present invention.

FIG. 5 illustrates an example of using the LED illuminating strip unit according to the preferred embodiment of the present invention.

FIG. 6 illustrates another example of using of the LED illuminating strip unit according to the preferred embodiment of the present invention.

### DETAILED DESCRIPTION OF THE PREFERRED EMBODIMENT

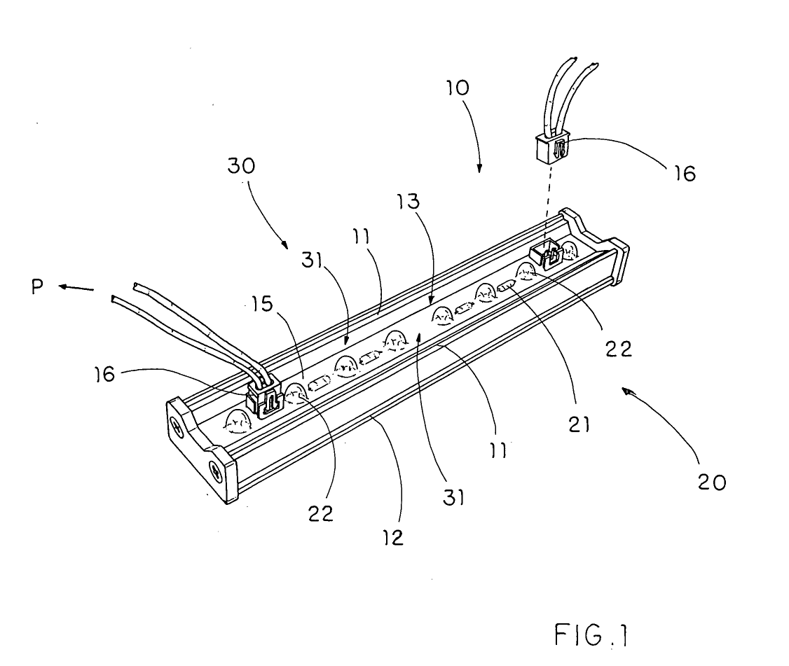

Referring to FIG. 1 of the drawings, a Light Emitted Diode (LED) illuminating strip unit according to a first preferred embodiment of the present invention is illustrated, in which the LED illuminating strip unit comprises an elongated support housing 10, an illumination unit 20, and a light merging arrangement 30.

The support housing 10 has two opposed sidewalls 11 upwardly extended from a bottom wall 12 of the support housing 10 to form a light accumulating channel 13 within the sidewalls 11 and the bottom wall 13.

The illumination unit 20 comprises a light circuit 21 supported by the support housing 10 for electrically connecting to a power source P and a plurality of illuminators 22 which are electrically mounted to the light circuit 21 and spacedly aligned along the light accumulating channel 13, wherein each of the illuminators 22 forms as a point of light source for radially emitting light within the light accumulating channel 13.

The light merging arrangement 30 is provided at the support housing 10 to reflectively accumulate the lights from the illuminators 22 within the light accumulating channel 13, so as to merge the points of light source to form a line of consistent light source along the light accumulating channel 13.

According to the preferred embodiment, the light merging arrangement 30 comprises two light reflective walls 31 formed along the sidewalls 11 of the light accumulating channel 13 respectively for reflectively accumulating the lights from the illuminators 22 to form the line of consistent light source along the light accumulating channel 13.

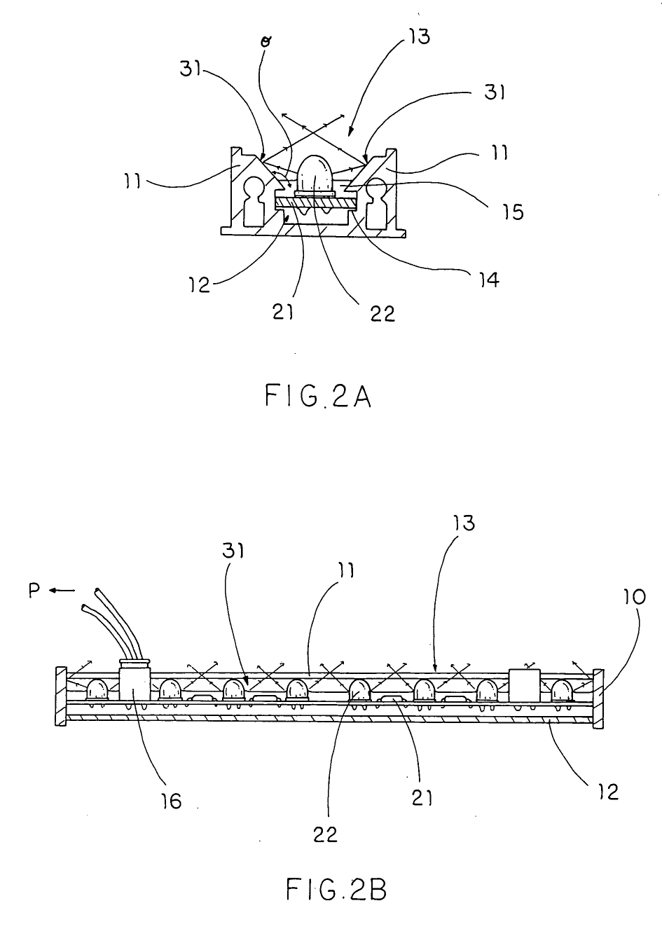

Referring to FIGS. 2A and 2B of the drawings, the sidewalls 11 of the light accumulating channel 13 are inclinedly and outwardly extended from the bottom wall 12 of the light accumulating channel 13 to the top portion of the support housing 10 such that when each of the illuminators 22 radially emits light, the light emitted would be reflected at the reflective walls 11 towards the light accumulating channel 13 so as to accumulate the light from illuminators 22 with the light accumulating channel 13. In other words, the light reflective walls 11 collect the light intensity of the illuminators 22 for forming the line of light source.

According to the preferred embodiment, the sidewalls 11 of the light accumulating channel 13 are continuously extended and inclined at an inclination angle θ with respect to the bottom wall 12 in which the inclination angle θ corresponds with an emitting angle of the light of the illuminators 22 for effectively accumulating light intensity which is to be emitted as a single line of light source.

Referring to FIGS. 2A and 2B of the drawings, according to the preferred embodiment, the light circuit 21 is supported on a bottom wall 12 of the light accumulating channel 13 wherein the illuminators 22 are electrically mounted on the electric circuit 21 within the light accumulating channel 13. Thus, it follows that the support housing 10 further comprises a supporting base 14 downwardly extended from the two sidewalls 11 for substantially supporting the illumination unit 20.

The illuminators 22 are preferably embodied as a plurality of regular Light Emitting Diodes (LEDs) each having a predetermined color of illumination, and is spacedly mounted by the supporting frame 10 in the accumulating channel 13 in such a manner that each illuminator 22 is arranged to optically communicate with each other to form the line of light source.

It is thus worth mentioning that the illuminators 22, being a plurality of LEDs, are conventionally capable of emitting light in an angle of approximately 120° (the projecting angle) radially from the respective LED. As a result, in order to optically accumulate the light from each LED to form a line of light source, the reflective inclination angle θ is preferably larger than 90° and smaller than 180° with respect to the bottom wall 12 of the light accumulating channel 13.

Accordingly, the light circuit 21 comprises a IC board securely supported within the support housing 10 wherein a leg portion of each of the illuminators 22 is electrically mounted on the IC board such that when the light circuit 21 is electrically connected to a power source, the illuminators 22 are electrically connected to radially emit the lights towards the sidewalls 11 so as to being reflected by the light reflective walls 31 of the light merging arrangement 30.

As the light circuit 21 supports on the bottom wall 12 of the light acuminating channel 13, the support housing 10 further comprises a sealing element 15 sealedly mounted along the light accumulating channel 13 to seal the light circuit 21 on the bottom wall 12 thereof such that a head portion of each of the illuminators 22 is protruded from the sealing element 15 for radially emitting the light within the light accumulating channel 13 as the point of light source.

Accordingly, the sealing element 15 is embodied as a transparent insulating layer, such as resin, coated on the light circuit 21 to seal the light circuit 21 within the light accumulating channel 13 such that the light generated from each of the illuminator 22 is able to reach the reflective walls 31.

Referring to FIG. 2B of the drawings, the LED illuminating strip unit further comprises at least an electric input 16 electrically extended from the light circuit 21 for adapting with the power source P. Accordingly, the electric input 16 is embodied as an electric inlet provided at an end portion on the electric circuit 21 wherein the electric inlet of the electrical input 16 is adapted to be connected to an electrical source for acquiring electrical power to light up the illuminators 22. It is worth to mention that two or more LED illuminating strip units of the present invention can be electrically connected together via an electric wire by electrically connecting two ends of the electric wire with the electric inputs 16 of the LED illuminating strip units. Therefore, the LED illuminating strip unit forms as a single light module that the LED illuminating strip units are able to link together to extend the line of light source.

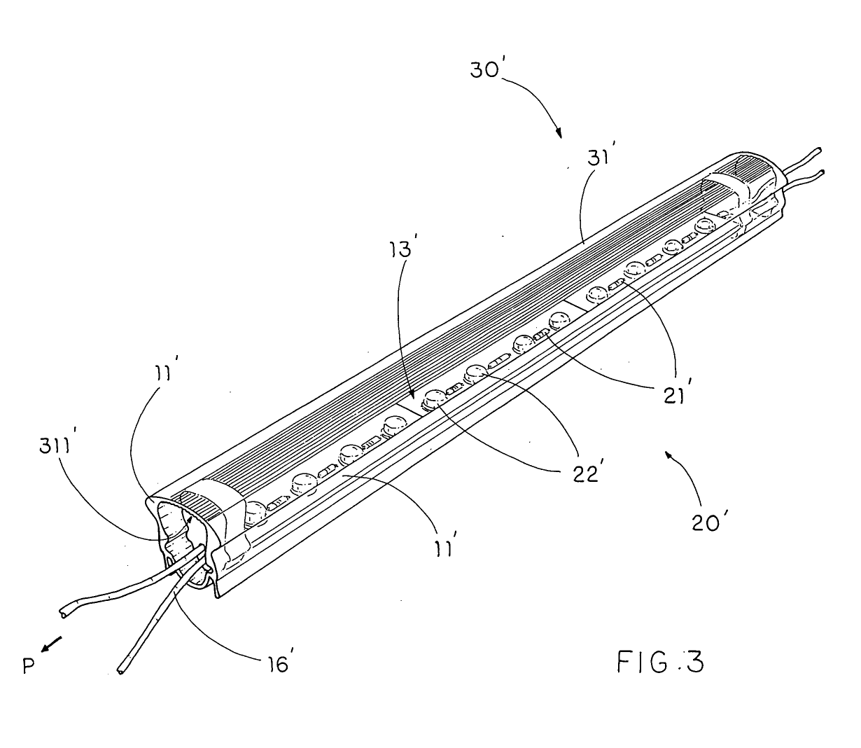

Alternatively, the electric inlets 16′ may be provided on the end of the electric circuit 21′ for sidewardly extending to connect with an electric source via a plurality of electric wires, as shown in FIG. 3 of the drawings.

In order to enhance the reflecting quality of the support housing 10, the light reflective walls 31 are two light reflective layers coated on the sidewalls 11 of the light accumulating channel 13 respectively for enhancing the reflection performance of the light in the light accumulating channel 13. It is worth pointing out that since the single line of light source of the present invention is derived by multiple reflections taken place in the light accumulating channel 13, it is of utmost importance in maintaining sound reflectivity of the light reflective walls 31. That's why the light reflective layer. It is preferably embodied as a reflective coating, such as a sliver coating, having a predetermined reflectivity for multiple reflecting lights in the light accumulating channel 13 to form a line of light source by subsequent interferences between the reflecting light.

It is worth mentioning that the support housing may be fabricated in a wide variety of integral structures having a predetermined shape for fitting the most suitable circumstances. For example, the support housing 10 may form the twenty six English alphabets to constitute a predetermined English vocabulary, such as “EXIT” or “OPEN”.

Referring to FIG. 3 of the drawings, a LED illuminating strip according to the second embodiment illustrates an alternative mode of the first embodiment of the present invention, wherein the support housing 10′, which is made transparent material, having two opposed sidewalls 11′ upwardly extended from a bottom wall 12′ of the support housing 10′ to form a light accumulating channel 13′ within the sidewalls 11′ and the bottom wall 13′.

The illumination unit 20′ comprises a light circuit 21′ supported by the support housing 10 for electrically connecting to a power source P and a plurality of illuminators 22′ which are electrically mounted to the light circuit 21′ and spacedly aligned along the light accumulating channel 13′, wherein each of the illuminators 22′ forms as a point of light source for radially emitting light within the light accumulating channel 13′.

The light merging arrangement 30′ is provided at the support housing 10′ to reflectively accumulate the lights from the illuminators 22′ within the light accumulating channel 13′, so as to merge the points of light source to form a line of consistent light source along the light accumulating channel 13′.

Accordingly, the light circuit 21′ comprises a IC board securely supported within the support housing 10′ wherein a leg portion of each of the illuminators 22′ is electrically mounted on the IC board such that when the light circuit 21′ is electrically connected to a power source, the illuminators 22′ are electrically connected to radially emit the lights towards the sidewalls 11′ so as to being reflected by the light reflective walls 31′ of the light merging arrangement 30′.

The illuminators 22′ are preferably embodied as a plurality of regular Light Emitting Diodes (LEDs) each having a predetermined color of illumination, and is spacedly mounted by the supporting frame 10′ in the accumulating channel 13′ in such a manner that each illuminator 22′ is arranged to optically communicate with each other to form the line of light source.

It is thus worth mentioning that the illuminators 22′, being a plurality of LEDs, are conventionally capable of emitting light in an angle of approximately 120° (the projecting angle) radially from the respective LED. As a result, in order to optically accumulate the light from each LED to form a line of light source, the reflective inclination angle θ is preferably larger than 90° and smaller than 180° with respect to the bottom wall 12′ of the light accumulating channel 13′.

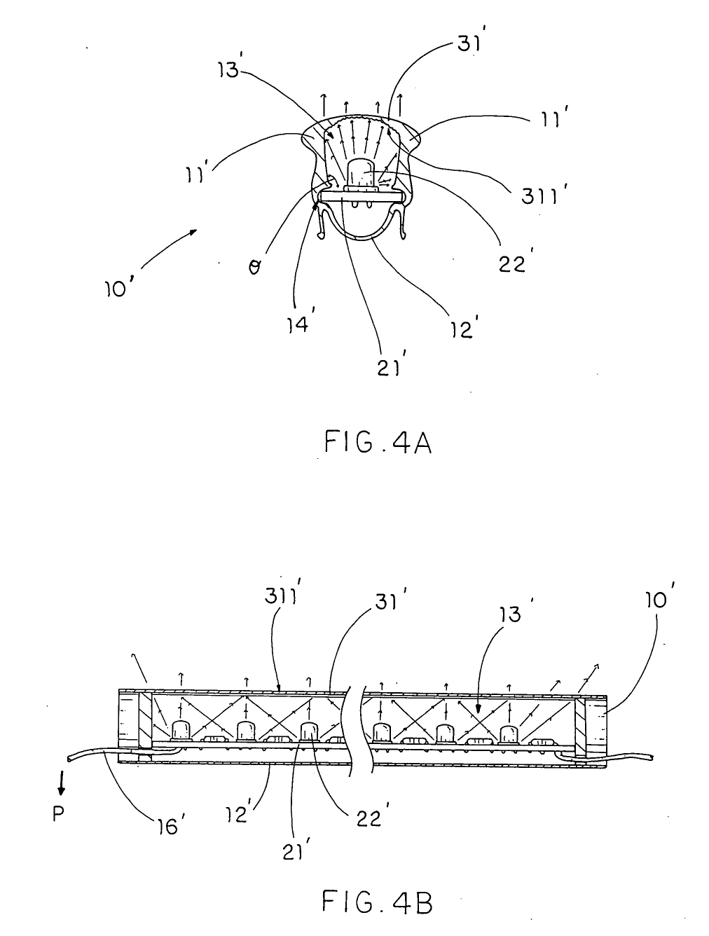

As shown in FIGS. 4A and 4B, the light merging arrangement 30′ comprises a transparent light guiding cover 31′ mounted on the support housing 10′ to enclose the light accumulating channel 13′, wherein a plurality of light guiding grooves 311′ are spacedly and longitudinally extended along the light guiding cover 31′ in such a manner that when the lights are emitted from the illuminators 22′ towards the light guiding cover 31′, the lights are guided along the light guiding grooves 311′ to merge the points of light source so as to form the line of consistent light source along the light accumulating channel 13′.

The light guiding cover 31′ is integrally extended from the sidewalls 11′ of the support housing 10′ to form a tubular member such that the illumination unit 20′ is sealedly received within the light accumulating channel 13′. In other words, the light guiding cover 31′ is upwardly and integrally extended from the sidewalls 11′ to form a utility shelter on top of the light circuit 21′.

As shown in FIGS. 4A and 4B, the light guiding grooves 311′ are longitudinally indent on an inner side of the light guiding cover 31′ such that when the illuminators 22′ generate the light towards the inner side of the light guiding cover 31′, the light is guided to project along the light guiding grooves 311′ so as to merge the light into the line of light source along the light accumulating channel 13′.

In addition, the sidewalls 11′ of the light accumulating channel 13′ are inclinedly and outwardly extended from the bottom wall 12′ thereof in such a manner that when each of the illuminators 22′ radially emits light, the lights from the illuminators 22′ are accumulated within the light accumulating channel 13′ towards the light guiding cover 31′. The sidewalls 11′ of the light accumulating channel 13′ are continuously extended and inclined at a predetermined inclination angle θ with respect to the bottom wall 12′, wherein the inclination angle θ of each of the sidewalls 11′ corresponds with an emitting angle of the light of each of the illuminators 22′ for effectively accumulating light intensity which is to be emitted as the single line of light source.

In order to hold the illuminating unit 20′ in position, the support housing 10′ further has an elongated holding slot 14′ longitudinally extended from the bottom wall 12′ of the support housing 10′ such that the light circuit 21′ is sildably engaged with the holding slot 14′ to retain the illuminators 22′ along the light accumulating channel 13′.

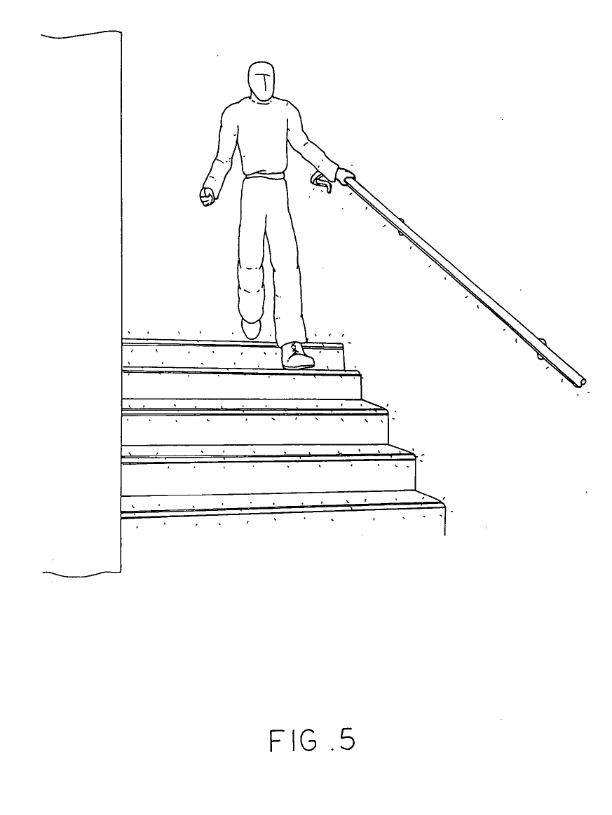

Referring to FIG. 5 of the drawings, a particular example application of the present invention is illustrated. The LED illuminating strip unit of the present invention may be utilized in a handrail and/or on the step of stairs so that during night time, the LED illuminating strip unit is capable of illuminating a line of light for alerting so as to guide people walking on the stairs. Thus, by way of an example, the likelihood of slipping on stairs can be substantially reduced. Especially when there is a fire, the LED illumination strip units are adapted to light up the handrail and/or on the step of stairs such that people are able to see the handrail and/or on the step of stairs under smoky condition for escape.

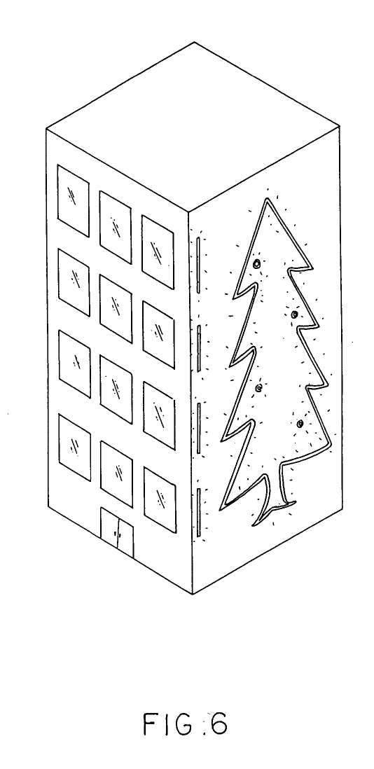

In addition, the LED illuminating strip units can be used as a light decoration by mounting the LED illuminating strip units on the outer wall of the building. For example, the LED illuminating strip units are artistically attached to the outer wall of the building to form as a Christmas lighting device, as shown in FIG. 6. Since the LED illuminating strip unit requires relatively small amount of electric power for operation, the user is able save consumption energy and operation cost to utility the LED illuminating strip unit of the present invention.

It is important to realize that since the support housing 10 of the present invention may be embodied as an elongated structure, or indeed any other shape, there is no need to chain a plurality of LED illuminating strip unit together to form a longer line of light source. In other words, no extra connecting wires, and so as the disadvantages attached thereto, such as unsecured and vulnerable connection, are required.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A LED illuminating strip unit, comprising:
an elongated support housing having two opposed sidewalls upwardly extended from a bottom wall of said elongated support housing to form a light accumulating channel within said sidewalls and said bottom wall;
an illumination unit comprising a light circuit supported by said support housing for electrically connecting to a power source and a plurality of illuminators which are electrically mounted to said light circuit and spacedly aligned along said light accumulating channel, wherein each of said illuminators forms as a point of light source for radially emitting light within said light accumulating channel; and
a light merging arrangement provided at said support housing to reflectively accumulate said lights from said illuminators within said light accumulating channel, so as to merge said points of light source to form a line of consistent light source along said light accumulating channel.

2. The LED illuminating strip unit, as recited in claim 1, wherein said light merging arrangement comprises two light reflective walls formed along said sidewalls of said light accumulating channel respectively for reflectively accumulating said lights from said illuminators to form said line of consistent light source along said light accumulating channel.

3. The LED illuminating strip unit, as recited in claim 2, wherein said sidewalls of said light accumulating channel are inclinedly and outwardly extended from said bottom wall thereof in such a manner that when each of said illuminators radially emits light, said lights from said illuminators are reflected at said light reflective walls towards said light accumulating channel so as to accumulate said lights within said light accumulating channel.

4. The LED illuminating strip unit, as recited in claim 3, wherein said sidewalls of said light accumulating channel are continuously extended and inclined at a predetermined inclination angle with respect to said bottom wall, wherein said inclination angle of each of said sidewalls corresponds with an emitting angle of said light of each of said illuminators for effectively accumulating light intensity which is to be emitted as said single line of light source.

5. The LED illuminating strip unit, as recited in claim 1, further comprising a sealing element sealedly mounted along said light accumulating channel to seal said light circuit on said bottom wall thereof such that a head portion of each of said illuminators is protruded from said sealing element for radially emitting said light within said light accumulating channel as said point of light source.

6. The LED illuminating strip unit, as recited in claim 2, further comprising a sealing element sealedly mounted along said light accumulating channel to seal said light circuit on said bottom wall thereof such that a head portion of each of said illuminators is protruded from said sealing element for radially emitting said light within said light accumulating channel as said point of light source.

7. The LED illuminating strip unit, as recited in claim 4, further comprising a sealing element sealedly mounted along said light accumulating channel to seal said light circuit on said bottom wall thereof such that a head portion of each of said illuminators is protruded from said sealing element for radially emitting said light within said light accumulating channel as said point of light source.

8. The LED illuminating strip unit, as recited in claim 1, further comprising at least an electric input electrically extended from said light circuit for adapting with said power source.

9. The LED illuminating strip unit, as recited in claim 3, further comprising at least an electric input electrically extended from said light circuit for adapting with said power source.

10. The LED illuminating strip unit, as recited in claim 7, further comprising at least an electric input electrically extended from said light circuit for adapting with said power source.

11. The LED illuminating strip unit, as recited in claim 1, wherein said light merging arrangement comprises a transparent light guiding cover mounted on said support housing to enclose said light accumulating channel, wherein a plurality of light guiding grooves are spacedly and longitudinally extended along said light guiding cover in such a manner that when said lights are emitted from said illuminators towards said light guiding cover, said lights are guided along said light guiding grooves to merge said points of light source so as to form said line of consistent light source along said light accumulating channel.

12. The LED illuminating strip unit, as recited in claim 11, wherein said light guiding cover is integrally extended from said sidewalls of said support housing to form a tubular member such that said illumination unit is sealedly received within said light accumulating channel.

13. The LED illuminating strip unit, as recited in claim 11, wherein said sidewalls of said light accumulating channel are inclinedly and outwardly extended from said bottom wall thereof in such a manner that when each of said illuminators radially emits light, said lights from said illuminators are accumulated within said light accumulating channel towards said light guiding cover.

14. The LED illuminating strip unit, as recited in claim 12, wherein said sidewalls of said light accumulating channel are inclinedly and outwardly extended from said bottom wall thereof in such a manner that when each of said illuminators radially emits light, said lights from said illuminators are accumulated within said light accumulating channel towards said light guiding cover.

15. The LED illuminating strip unit, as recited in claim 13, wherein said sidewalls of said light accumulating channel are continuously extended and inclined at a predetermined inclination angle with respect to said bottom wall, wherein said inclination angle of each of said sidewalls corresponds with an emitting angle of said light of each of said illuminators for effectively accumulating light intensity which is to be emitted as said single line of light source.

16. The LED illuminating strip unit, as recited in claim 14, wherein said sidewalls of said light accumulating channel are continuously extended and inclined at a predetermined inclination angle with respect to said bottom wall, wherein said inclination angle of each of said sidewalls corresponds with an emitting angle of said light of each of said illuminators for effectively accumulating light intensity which is to be emitted as said single line of light source.

17. The LED illuminating strip unit, as recited in claim 11, wherein said support housing further has an elongated holding slot longitudinally extended from said bottom wall of said support housing such that said light circuit is sildably engaged with said holding slot to retain said illuminators along said light accumulating channel.

18. The LED illuminating strip unit, as recited in claim 14, wherein said support housing further has an elongated holding slot longitudinally extended from said bottom wall of said support housing such that said light circuit is sildably engaged with said holding slot to retain said illuminators along said light accumulating channel.

19. The LED illuminating strip unit, as recited in claim 16, wherein said support housing further has an elongated holding slot longitudinally extended from said bottom wall of said support housing such that said light circuit is sildably engaged with said holding slot to retain said illuminators along said light accumulating channel.

20. The LED illuminating strip unit, as recited in claim 11, further comprising at least an electric input electrically extended from said light circuit for adapting with said power source.

21. The LED illuminating strip unit, as recited in claim 16, further comprising at least an electric input electrically extended from said light circuit for adapting with said power source.

22. The LED illuminating strip unit, as recited in claim 19, further comprising at least an electric input electrically extended from said light circuit for adapting with said power source.
